(19) United States
(12) Patent Application Publication
(10) Pub. No.: US 2007/0086590 A1
(43) Pub. Date: Apr. 19, 2007

(54) Method and apparatus for establishing a security association

(76) Inventor: Rolf Blom, Jarfalla (SE)

Correspondence Address: NIXON & VANDERHYE, PC, 901 NORTH GLEBE ROAD, 11TH FLOOR, ARLINGTON, VA, 22203, US

(21) Appl. No.: 11/248,589

(22) Filed: Oct. 13, 2005

(51) Int. Cl. H04L 9/00

(52) U.S. Cl. 380/278

(57) ABSTRACT

A method for establishing a security association between a client and a service node for the purpose of pushing information from the service node to the client, where the client and a key server share a base secret. The method comprises sending a request for generation and provision of a service key from the service node to a key server, the request identifying the client and the service node, generating a service key at the key server using the identities of the client and the service node, the base secret, and additional information, and sending the service key to the service node together with said additional information, forwarding said additional information from the service node to the client, and at the client, generating said service key using the received additional information and the base key.

### FIELD OF THE INVENTION

The present invention relates to a method and apparatus for establishing a security association between a client terminal and a service node in order to deliver a push-type service and in particular, though not necessarily, to such a method and apparatus which employs a Generic Bootstrapping Architecture.

### BACKGROUND TO THE INVENTION

In order to facilitate the provision of services to user terminals, a mobile network such as a 3G network will often require the establishment of a secure communication channel or “security association” between client terminals (i.e. mobile terminals) and the network-based service nodes which provide the services. The Generic Bootstrapping Architecture (GBA) is discussed in the 3GPP Technical Specification TS 33.220 and provides a mechanism whereby a client terminal (UE) can be authenticated to a Network Authentication Function (the service node), and secure session keys obtained for use between the client terminal and the Network Authentication Function. The simple network model for this architecture is illustrated in FIG. 1. This mechanism bootstraps upon the known Authentication and Key Agreement (AKA) procedure [3GPP TS 33.102] which allows a client terminal to be authenticated to a Bootstrapping Server Function (BSF) of the client's home network on the basis of a secret K which is shared between the USIM of the client terminal and the Home Subscriber System (HSS) of the subscriber's home network. The AKA procedure further establishes session keys that are afterwards applied between the client terminal and the operator-controlled Network Application Function (NAF). When a client terminal and NAF wish to obtain session keys from the BSF, the NAF sends a transaction identifier to the BSF, the transaction identifier containing an index which the BSF uses to identify the client terminal and appropriate keys which it forwards to the NAF.

According to the GBA mechanism, a UE initiates the key generation process by sending a request containing a user identity to the BSF. The request also contains the identity of the NAF. The BSF retrieves an authentication vector from the Home Subscriber System (HSS), each authentication vector consisting of a random number RAND, an expected response XRES, a cipher key CK, an integrity key IK and an authentication token AUTN. The BSF generates key material KS by concatenating CK and IK contained within the authentication vector. The BSF generates a key identifier B-TID in the format of a NAI by base64 encoding the RAND value and combining the encoded value with the BSF server name, i.e. as
base64encode(RAND)@BSF_servers_domain_name.

The BSF retains the key KS in association with the transaction identifier B-TID and the NAF identity. The B-TID and AUTN are sent by the BSF to the UE, the USIM of the client terminal verifying the value AUTN using the shared secret K and returning a digest of the expected result XRES to the BSF. The USIM also generates the key material KS using the secret K and the value RAND (recovered from the B-TID).

Following completion of this procedure, the UE communicates to the NAF, the received B-TID. The NAF and the BSF are authenticated to one another, and the NAF sends to the BSF the received B-TID together with its own identity. The BSF uses the B-TID and the identity of the NAF to locate the correct key KS, and uses KS to generate a NAF key. Other information such as the NAF identity is also used in the generation of the NAF key. The generated NAF key is returned to the NAF. The UE is similarly able to generate the NAF key using the key KS that it has already generated.

After the GBA mechanism has been run for the first time, subsequent requests to establish a security association between the UE and the same or a different NAF may use the already established key material KS, providing that key has not expired. However, this will still require that the UE initiate a request for establishment of a security association by sending its B-TID to the NAF.

### SUMMARY OF THE INVENTION

There are occasions on which it is desirable to allow the NAF to initiate the establishment of a security association with the UE. For example, one might consider a push-type service, which delivers news, sports, and financial, etc information to users who have previously registered for a service. A typical operational procedure to achieve this might be for the service provider to send an SMS message to the UE which requests the user to open a secure connection. However, there are many threats related to this model as an SMS might be manipulated, sent by an unauthorized party, be replayed, etc. If a security association existed, or the service node could initiate one, before the actual service data is sent, security procedures could be based on this and most problems could be mitigated.

According to a first aspect of the present invention there is provided a method of establishing a security association between a client and a service node for the purpose of pushing information from the service node to the client, where the client and a key server share a base secret, the method comprising:
sending a request for generation and provision of a service key from the service node to a key server, the request identifying the client and the service node;
generating a service key at the key server using the identities of the client and the service node, the base secret, and additional information, and sending the service key to the service node together with said additional information;
forwarding said additional information from the service node to the client; and
at the client, generating said service key using the received additional information and the base secret.

It will be appreciated that the key server may be a stand-alone node or may be a distributed server. In the case of a 3G network employing the Generic Bootstrapping Architecture, a Bootstrapping Server Function and a Home Subscriber Server may together provide the key server, where the Bootstrapping Server Function communicates with the service node and with the Home Subscriber Server. In the case of a 2G network, the key server may be a combination of a Bootstrapping Server Function and an AuC server.

In the case of a 3G network employing the Generic Bootstrapping Architecture, the service node comprises a Network Application Function. The step of generating a service key at the key server comprises the steps of:
generating key material KS using the identities of the client and the service node, and said base secret; and
generating the service key using said key material KS and said additional information.

The step of generating the service key at the client also comprises these two steps.

Said step of generating a service key at the key server may utilise values other than those sent to the client by the service node. The client may obtain certain of those other values from the key server.

Said additional information may comprise one or more of:
a random value;
time stamp;
sequence number;
other identifiers

Said additional information may comprise a transaction identifier in the format of an NAI, and comprising an encoded random value.

Said additional information may be forwarded from the service node to the client in a message also containing service data, the service data being encrypted with the service key, wherein the client can decrypt the encrypted data once it has generated the service key.

In one embodiment of the invention, the key server sends to the service node a network authentication value. The service node forwards this value to the client, together with said additional information. The client uses the base secret and the authentication value to authenticate the key server. Only if the key server is authenticated does the client generate and use the service key.

In an alternative embodiment of the invention, the client requests an authentication value from the key server after it has received said additional information from the service node. Only when the client has authenticated the key server is the service key generated and used.

The terminal may comprise means for receiving from the service node a message authentication code, the terminal comprising means for generating an authentication key or keys from at least a part of the key generation information, and using the authentication key(s) to authenticate the message authentication code. The generation means may be a USIM/ISIM.

According to a second aspect of the present invention there is provided a service node for delivering a push service to a client via a secure communication link, the service node comprising:
means for sending a request for generation and provision of a service key to a key server, the request identifying the client and the service node;
means for receiving from the key server a service key together with said additional information;
means for forwarding said additional information to the client; and
means for encrypting and/or integrity protecting service information using the service key and for sending the encrypted and/or protected information to the client.

According to a third aspect of the invention there is provided a client terminal for receiving a pushed service delivered by a service node, the client terminal comprising:
memory means for storing a secret that is shared with a key server;
means for receiving from said service node, key generation information;
means for generating a service key using said shared secret and said key generation information; and
means for using said service key to decrypt and/or verify the integrity of communications with the service node.

According to a fourth aspect of the present invention there is provided a key server for use in establishing a security association between a client and a service node for the purpose of pushing information from the service node to the client, the key server comprising:
memory means for storing a secret that is shared with said client;
means for receiving a request for generation and provision of a service key from said service node, the request identifying the client and the service node; and
means for generating a service key using the identities of the client and the service node, the base secret, and additional information, and for sending the service key to the service node together with said additional information.

### BRIEF DESCRIPTION OF THE DRAWINGS

FIG. 1 illustrates a simple network model for the Generic Bootstrapping Architecture; and

FIGS. 2 to 4 illustrates signalling flows associated with respective procedures for establishing a security association between a client (UE) and NAF.

### DETAILED DESCRIPTION OF CERTAIN EMBODIMENTS

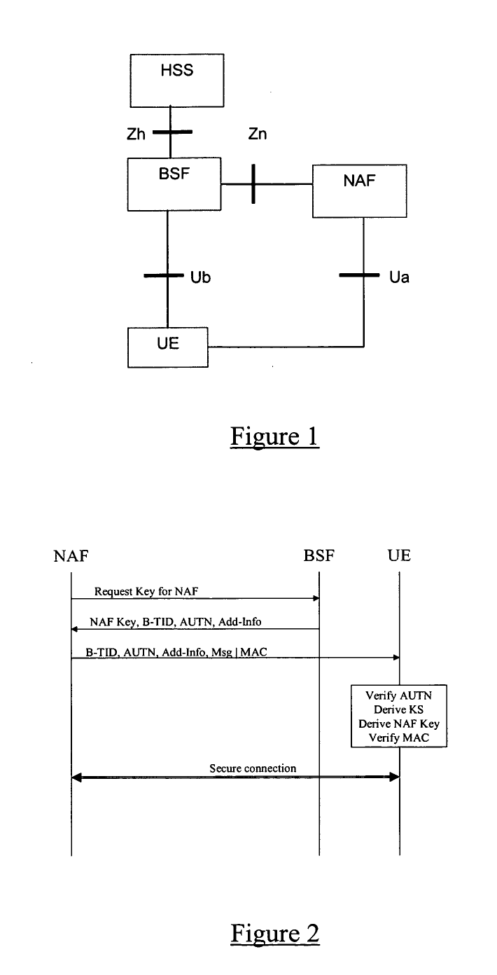

The general Generic Bootstrapping Architecture (GBA) for 3G networks has been described with reference to FIG. 1, which illustrates the various interfaces (Ua, Ub, Zn, and Zh) between the various entities. It should be borne in mind that the description is on a relatively high level and actual implementations may “look” different whilst employing the same general functionality. For example, it is possible that when a BSF receives a service key request from a NAF (as will be described below), the receiving BSF must perform an address resolution step to identify a “serving” BSF for the NAF or client (UE) and, if the receiving BSF is not the serving BSF, the request is forwarded on to the serving BSF.

This discussion concerns the provision of a push service to a client. Typically, the client will have pre-registered with the service provider, but the initiative to push particular information is taken by the service provider. In such a situation, the service provider and the client will not already have a security association established with each other (security associations are typically short-lived), and one must be established.

A first solution proposed here takes the approach that the NAF asks the BSF for a NAF (or service) key. The BSF returns to the NAF, the NAF key together with the client transaction identifier (B-TID) and the corresponding network authentication value (AUTN). As has been stated above, the B-TID contains the encoded RAND value (as the NAI prefix), which can be used by the client to derive the base key (KS). The NAF can now compose a message containing the B-TID, AUTN, and other data (e.g. the NAF “name”) that the client requires in order to derive the NAF key, and send this message to the client. This message can be a message that only triggers the set-up of a SA (i.e. sharing of a service key) or it could contain service data (i.e. payload data) encrypted with the service key. In both cases, the values B-TID, AUTN, and other data required by the client to generate KS are sent in plain text but are “signed” with a Message Authentication Code.

When the client receives the message, it retrieves the RAND part of the B-TID (by reversing the encoding) and the AUTN and applies them to the USIM/ISIM to derive the base key Ks. Then it uses the additional information to derive the NAF key, and verifies the received message using the MAC.

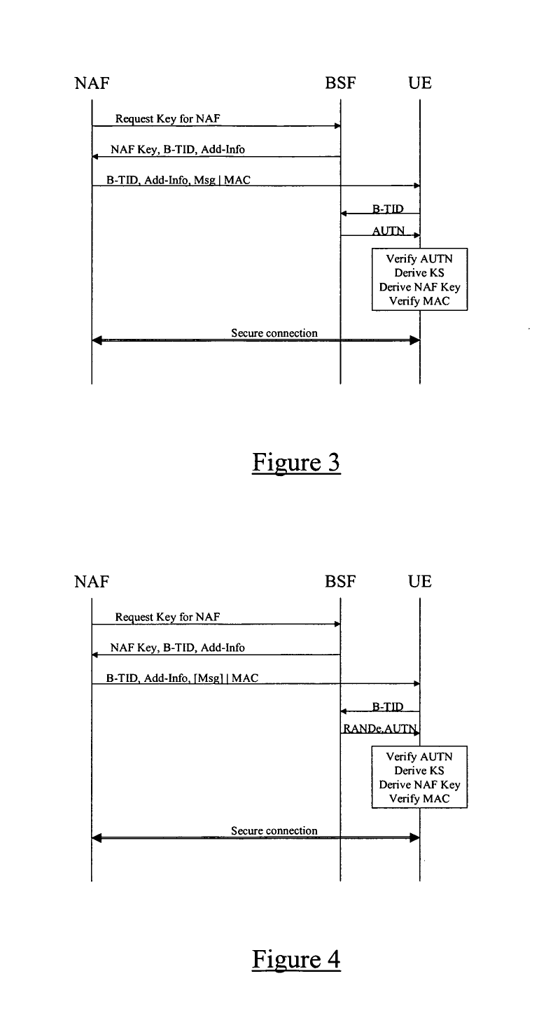

The signalling exchanges associated with this procedure are illustrated in FIG. 2.

In order to prevent the manipulation of the additional information (required by the client) by the NAF, the BSF may sign that information using a derivative of KS. This may be important, for example, to prevent the NAF from extending the lifetime of a key.

The solution presented allows the NAF to push to the client the information required to establish a security association between the two parties. Thus the client does not have to set up a connection with the BSF to perform these tasks. This represents an extremely time efficient solution. However, it requires that the NAF relay all key related information (key lifetime, Add-info, etc) in a protected form from the BSF to UE. The B-TID and the other information might then comprise quit a large data structure. This might be problematic in the case where the volume of data that can be incorporated into the message structure used between the client and the NAF, e.g. where this structure is SMS.

In order to reduce the required data volume exchanged between the NAF and the client to establish the security association, the above solution may be modified by omitting the AUTN value from the data sent by the BSF to the NAF. The NAF now composes a message containing the B-TID and other necessary data that the terminal needs to derive the NAF key and sends it to the client. Again, this message could be a message which only triggers the set-up of a security association, or it could contain encrypted payload data.

When the client receives the message from the NAF, it connects to the BSF transmitting the B-TID thereto, authenticates itself, and requests the remaining information necessary to derive the key KS associated with the B-TID, i.e. e.g. AUTN. After having received this information it derives the service (NAF) key and verifies the integrity of the message. As the client has to connect to the BSF, it can at the same time get all the information related to the base key KS, i.e. Add-Info, key life time etc, thus reducing the amount of “administrative” information that has to be transmitted from the NAF to client.

The signalling exchanges associated with this procedure are shown in FIG. 3.

It may be undesirable in some circumstances to reveal the value RAND to the NAF. This may be avoided by forming the B-TID using a reference to the actual RAND value (or the effective RAND, RANDe), so that the NAF sees only the reference value. The effective RAND (RANDe) would then have to be signalled together with the AUTN from the BSF to the client. This modified procedure is illustrated in FIG. 4.

The main advantage of the solutions described with reference to FIGS. 3 and 4 is that the BSF will have a further opportunity to control of the key generation in the client.

The client needs the AUTN to derive the key. On the other hand, the client will have to connect to the BSF and authenticate itself towards the BSF requiring a new variant of the GBA protocol over the Ub interface.

One threat to the solutions of FIGS. 3 and 4 is that an attacker might generate a batch of messages (purporting to contain a valid B-TID) and send them to different clients to launch a Denial-of-Service (DoS) attack. As the clients have no means to authenticate the messages (i.e. a AUTN), they will connect to the BSF in an attempt to authenticate the received messages. Such an attack will, if not resisted, consume considerable resources on the part of the BSF. To make such a DoS attack more difficult, it would be desirable to enable the client to immediately check the MAC of the message pushed by the NAF in order to validate the message without having to connect to the BSF. To achieve this, the client has to be able to derive the key that is used for the MACing of the message. As the AUTN is not sent to the client in the pushed message, this derivation has to be based only on the RAND (or derived value, FIG. 4) in the B-TID.

A solution is to use the RAND (or derived value) in the B-TID to derive two keys Ck′ and Ik′ at the BSF. The BSF then derives a MAC key using these keys, and sends the MAC value to the NAF. This integrity key should preferably also depend on the NAF identity. Using a “fingerprint” of the “other necessary information needed to derive the NAF key, in the derivation of the integrity key would be one way to achieve this without having to send all the information to the UE. The NAF computes a MAC over at least a part of the data to be sent to the client, and includes the MAC in the message sent to the client. At the client, the USIM/ISIM uses the standard AKA algorithms to generate Ck′ and Ik′ and hence the MAC key, and the client can then verify the message. Alternatively, the BSF can provide the keys Ck′ and Ik′ to the NAF to enable the NAF to generate the MAC key itself. This doesn't stop replay of old message (although this could be addressed with the use of timestamps) but it does stop attackers from generating random messages.

It will be appreciated by the person of skill in the art that various modifications may be made to the above described embodiments without departing from the scope of the present invention. For example, whilst the solutions presented above have been concerned with GBA, the invention has general applicability to architectures where information is to be pushed from a service provider and where the service provider and the client do not share a common secret.

1. A method for establishing a security association between a client and a service node for the purpose of pushing information from the service node to the client, where the client and a key server share a base secret, the method comprising:
* sending a request for generation and provision of a service key from the service node to a key server, the request identifying the client and the service node;
generating a service key at the key server using the identities of the client and the service node, the base secret, and additional information, and sending the service key to the service node together with said additional information;
forwarding said additional information from the service node to the client; and
at the client, generating said service key using the received additional information and the base secret.

2. A method according to claim 1, wherein said client is a client terminal of a 3G network employing a Generic Bootstrapping Architecture, said service node comprising a Network Application Function and said key server comprising a Bootstrapping Server Function.

3. A method according to claim 2, said step of generating a service key at the key server comprising the steps of:
generating key material KS using the identities of the client and the service node, and said base secret; and
generating the service key using said key material KS and said additional information.

4. A method according to claim 2, said step of generating said service key at the client comprising:
generating key material KS using the identities of the client and the service node, and said base secret; and
generating the service key using said key material KS and said additional information.

5. A method according to claim 4, wherein said base secret is stored in an ISIM/USIM of the client, and said step of generating the key material KS is performed within the ISIM/USIM.

6. A method according to claim 1, said step of generating a service key at the key server utilising values other than those sent to the client by the service node.

7. A method according to claim 6, wherein at least certain of those other values are obtained by the client from the key server.

8. A method according to claim 1, wherein said additional information comprises one or more of:
a transaction identifier; and;
a network authentication value.

9. A method according to claim 1, wherein said additional information comprises a transaction identifier in the format of an NAI, the transaction identifier comprising an encoded random value generated by the key server, the encoded random value being used to generate the service key.

10. A method according to claim 1, wherein said additional information comprises a transaction identifier in the format of an NAI, the transaction identifier comprising a pointer to a random value generated by and stored at the key server, the random value being used to generate the service key, the method comprising sending a request containing said pointer from the client to the key server, and returning the random value to the client to enable the client to generate the service key.

11. A method according to claim 1, wherein the key server sends to the service node a network authentication value and the service node forwards this value to the client, together with said additional information, the client using the base secret and the authentication value to authenticate the key server.

12. A method according to claim 1 and comprising sending a request from the client to the key server for an authentication value after the client has received said additional information from the service node, receiving the authentication value at the client, and authorising the security association request received from the service node on the basis of this value.

13. A method according to claim 1, wherein said additional information is forwarded from the service node to the client in a message also containing service data, the service data being encrypted and/or integrity protected with the service key, wherein the client can decrypt the encrypted data once it has generated the service key.

14. A service node for delivering a push service to a client via a secure communication link, the service node comprising:
means for sending a request for generation and provision of a service key to a key server, the request identifying the client and the service node;
means for receiving from the key server a service key together with said additional information;
means for forwarding said additional information to the client; and
means for encrypting and/or integrity protecting service information using the service key and for sending the encrypted/protected information to the client.

15. A client terminal for receiving a pushed service delivered by a service node, the client terminal comprising:
memory means for storing a secret that is shared with a key server;
means for receiving from said service node, key generation information;
means for generating a service key using said shared secret and said key generation information; and
means for using said service key to decrypt and/or verify the integrity of communications with the service node.

16. A terminal according to claim 15 and comprising means for receiving from the service node a message authentication code, the terminal comprising means for generating an authentication key or keys from at least a part of the key generation information, and using the authentication key(s) to authenticate the message authentication code.

17. A terminal according to claim 16, wherein said means for generating an authentication key or keys comprises a USIM/ISIM.

18. A key server for use in establishing a security association between a client and a service node for the purpose of pushing information from the service node to the client, the key server comprising:
memory means for storing a secret that is shared with said client;
means for receiving a request for generation and provision of a service key from said service node, the request identifying the client and the service node; and
means for generating a service key using the identities of the client and the service node, the base secret, and additional information, and for sending the service key to the service node together with said additional information.
